(19) United States
(12) Patent Application Publication
(10) Pub. No.: US 2014/0184638 A1
(43) Pub. Date: Jul. 3, 2014

(54) ADAPTIVELY SCALING A VIDEO FRAME/IMAGE ELEMENT RENDERED ON A DATA PROCESSING DEVICE

(71) Applicants: Sathiyaraj Ramachandran, Tuticorin (IN); Harikesh Ancha, Kahammam (IN)

(72) Inventors: Sathiyaraj Ramachandran, Tuticorin (IN); Harikesh Ancha, Kahammam (IN)

(21) Appl. No.: 13/731,125

(22) Filed: Dec. 31, 2012

(51) Int. Cl. G09G 5/373; G09G 5/377

(52) U.S. Cl. CPC G09G 5/373; G09G 5/377
USPC 345/629

(57) ABSTRACT

A method includes sensing distance between a user of a data processing device and a display unit of the data processing device or the data processing device through a distance sensor, and storing an element associated with a video frame or an image being rendered on the display unit separately from data related to the video frame or the image in a memory associated with a processor of the data processing device. The method also includes scaling, through the processor, the element in accordance with the sensed distance to an appropriate size thereof, and overlaying, through the processor, the scaled element on the data related to the video frame or the image during rendering thereof on the display unit.

### FIELD OF TECHNOLOGY

This disclosure relates generally to data processing devices and, more particularly, to adaptively scaling a video frame/image element rendered on a data processing device.

### BACKGROUND

A data processing device (e.g., a mobile phone, a desktop computer, a laptop computer, a notebook computer, a netbook, a gaming console) may have a display unit on which a video frame or an image is rendered. A user of the data processing device may be located at a considerable distance from the data processing device. In the case of the display unit rendering a video frame from a movie, the user may not be able to clearly view a subtitle associated with the video frame. Further, the data processing device may provide for limited options to resize the subtitle such that the user is able to clearly view the subtitle. A repeated user requirement to resize the subtitle utilizing the limited options and/or to move closer to the data processing device may significantly inconvenience the user, leading to frustration thereof.

### SUMMARY

Disclosed are a method, a device and/or a system of adaptively scaling a video frame/image element rendered on a data processing device.

In one aspect, a method includes sensing distance between a user of a data processing device and a display unit of the data processing device or the data processing device through a distance sensor, and storing an element associated with a video frame or an image being rendered on the display unit separately from data related to the video frame or the image in a memory associated with a processor of the data processing device. The method also includes scaling, through the processor, the element in accordance with the sensed distance to an appropriate size thereof, and overlaying, through the processor, the scaled element on the data related to the video frame or the image during rendering thereof on the display unit.

In another aspect, a non-transitory medium, readable through a data processing device and including instructions embodied therein that are executable through the data processing device, is disclosed. The non-transitory medium includes instructions to sense distance between a user of the data processing device and a display unit of the data processing device or the data processing device through a distance sensor, and instructions to store an element associated with a video frame or an image being rendered on the display unit separately from data related to the video frame or the image in a memory associated with a processor of the data processing device. The non-transitory medium also includes instructions to scale, through the processor, the element in accordance with the sensed distance to an appropriate size thereof, and instructions to overlay, through the processor, the scaled element on the data related to the video frame or the image during rendering thereof on the display unit.

In yet another aspect, a data processing device includes a display unit, a memory having an element associated with a video frame or an image being rendered on the display unit stored separately from data related to the video frame or the image, a processor communicatively coupled to the memory, and a distance sensor to sense distance between a user of the data processing device and the display unit of the data processing device or the data processing device. The processor is configured to scale the element in accordance with the sensed distance to an appropriate size thereof, and to overlay the scaled element on the data related to the video frame or the image during rendering thereof on the display unit.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is a schematic view of a multimedia processing unit of the data processing device of FIG. 1 and a memory associated therewith, according to one or more embodiments.

FIG. 3 is a schematic view of an example distance sensor of the data processing device of FIG. 1.

FIG. 4 is a schematic view of another example distance sensor of the data processing device of FIG. 1.

FIG. 5 is a schematic view of interaction between a driver component and a processor of the data processing device of FIG. 1, according to one or more embodiments.

FIG. 6 is an illustrative view of scaling of a subtitle of a video frame rendered on a display unit of the data processing device of FIG. 1.

FIG. 7 is a process flow diagram detailing the operations involved in adaptively scaling a video frame/image element rendered on the data processing device of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of adaptively scaling a video frame/image element rendered on a data processing device. Although the present embodiments have been described with reference to specific example embodiments, it will be evident that various modifications and changes may be made to these embodiments without departing from the broader spirit and scope of the various embodiments.

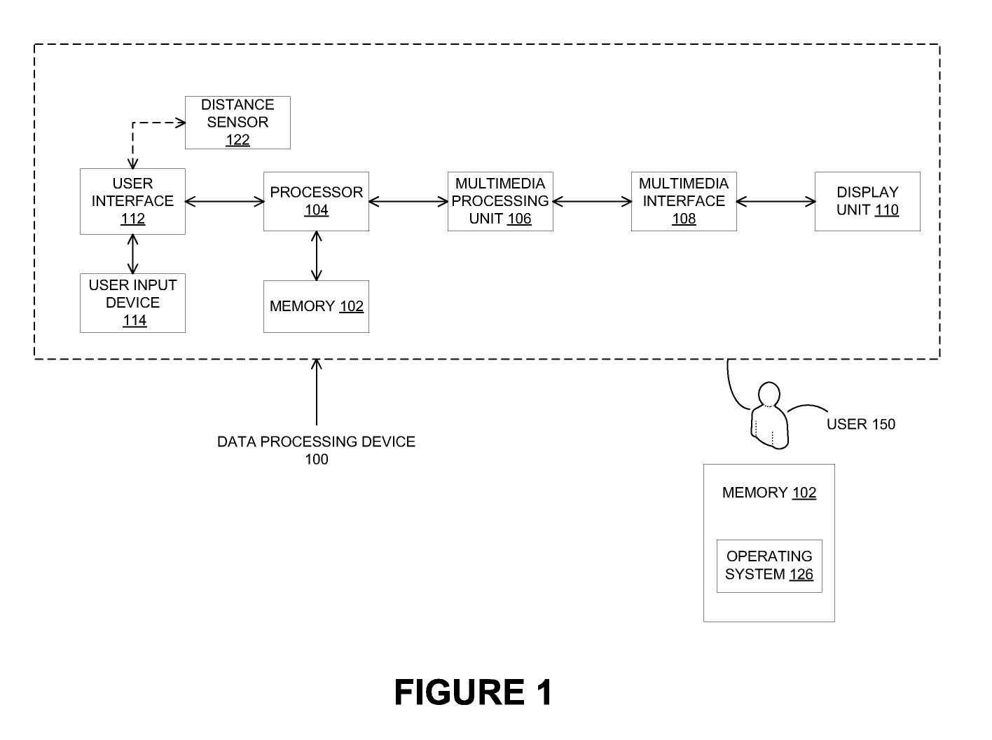

FIG. 1 shows a data processing device 100, according to one or more embodiments. In one or more embodiments, data processing device 100 may be a mobile device such as a mobile phone, a desktop computer, a laptop computer, a notebook computer, a netbook or a gaming console on which a user 150 may execute/play games available on non-transitory machine-readable media such as Compact Discs (CDs), Digital Video Discs (DVDs), Blu-Ray™ discs and gaming cartridges, or on downloaded files stored in a memory 102 (e.g., non-volatile memory) of data processing device 100.

In one or more embodiments, memory 102 of data processing device 100 may be a volatile memory (e.g., Random Access Memory (RAM)) and/or a non-volatile memory (e.g., Read-Only Memory (ROM), hard disk). In one or more embodiments, at least some portion of memory 102 (e.g., ROM) may be part of a processor 104 of data processing device 100. In one or more embodiments, processor 104 may include a Central Processing Unit (CPU) and/or a Graphics Processing Unit (GPU). In another embodiment, memory 102 may be separate from processor 104. In general, in one or more embodiments, processor 104 may be communicatively coupled to memory 102; memory 102 may include storage locations configured to be addressable through processor 104.

In one or more embodiments involving a GPU, the GPU may be configured to perform intensive graphics processing. Alternately, two or more GPUs may be provided in data processing device 100 to perform the abovementioned graphics processing. In one or more embodiments, when data processing device 100 is powered ON, instructions associated with loading an operating system 126 thereon stored in memory 102 (e.g., non-volatile memory) may be executed through processor 104.

In one or more embodiments, output data associated with processing through processor 104 may be input to a multimedia processing unit 106 configured to perform encoding/decoding associated with the data. In one or more embodiments, the output of multimedia processing unit 106 may be rendered on a display unit 110 through a multimedia interface 108 configured to convert data to an appropriate format required by display unit 110. In one or more embodiments, display unit 110 may be a computer monitor/display (e.g., Liquid Crystal Display (LCD) monitor, Cathode Ray Tube (CRT) monitor) associated with data processing device 100. In an alternate embodiment, display unit 110 may also be a monitor/display embedded in the gaming console.

In one or more embodiments, a user interface 112 (e.g., a game port, a Universal Serial Bus (USB) port) interfaced with processor 104 may be provided in data processing device 100 to enable coupling of a user input device 114 to processor 104 therethrough. In one or more embodiments, user input device 114 may include a keyboard/keypad and/or a pointing device (e.g., mouse, touch pad, trackball). In one or more embodiments, user input device 114 may also include a joystick or a gamepad. In one or more exemplary embodiments, data processing device 100 may include another user input device in the form of a distance sensor 122 associated therewith (e.g., by being embedded on data processing device 100, by transmitting data to another sensor of data processing device 100). It should be noted that distance sensor 122 has been shown as distinct from user input device 114 merely for the sake of clarity. In some embodiments, distance sensor 122 may be regarded as user input device 114.

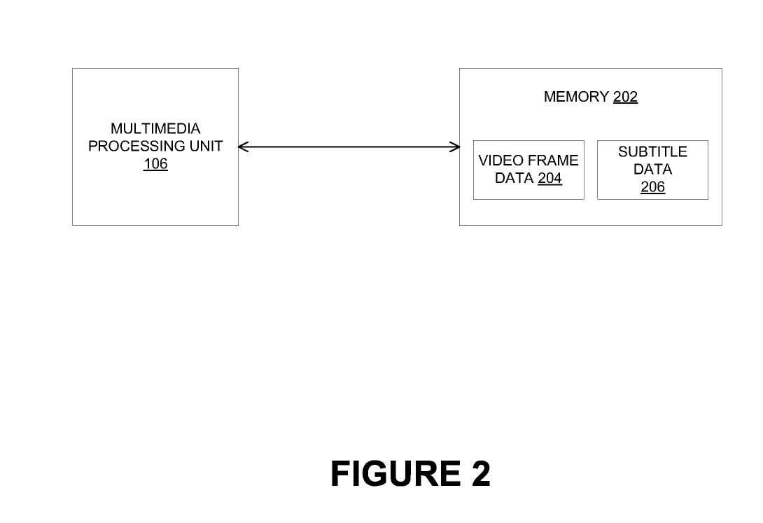

In an example scenario, a movie (or, a game) may be rendered on display unit 110 of data processing device 100. The movie may include video frames onto which subtitles may be overlaid (e.g., through multimedia processing unit 106; it should be noted that multimedia processing unit 106 may be processor 104 or, distinct from processor 104). FIG. 2 shows multimedia processing unit 106 and a memory 202 (e.g., same as memory 102 or, a different memory) associated therewith. Although not limiting, memory 202 here may, preferably, be a volatile memory. Memory 202 is shown to include video frame data 204 (obviously, data related to one or more video frames to be rendered) and subtitle data 206 (obviously, data related to one or more subtitles to be overlaid on the corresponding one or more video frames). The aforementioned frame data 204 and subtitle data 206 may be combined (e.g., overlaid) through multimedia processing unit 106 (or, processor 104; the scaling and overlaying may be part of the encoding process) and rendered on display unit 110.

In one or more embodiments, user 150 may be provided a capability to trigger a subtitle resizing process; the triggering may be possible through a physical button associated with data processing device 100 or display unit 110, clicking/touching a virtual button/interface on display unit 110, executing an appropriate application therefor and/or loading of operating system 126. In the case of loading of operating system 126, the triggering may be an automatic process going on in the background or foreground. Other forms of triggering are within the scope of the exemplary embodiments discussed herein. The triggering of the process may cause a distance between user 150 and data processing device 100/display unit 110 to be sensed through distance sensor 122. In one or more embodiments, the sensing may occur periodically; the sensing may also be continuous.

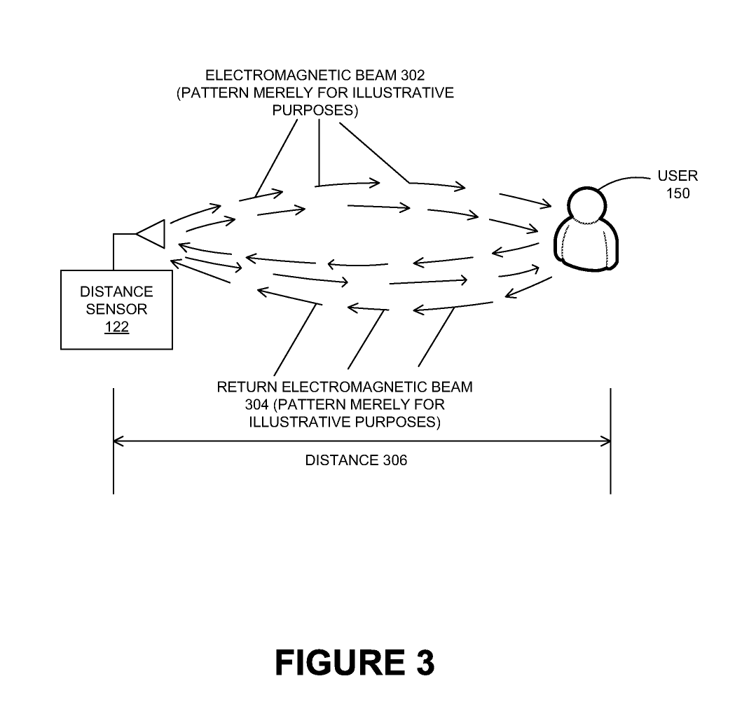

FIG. 3 shows an example distance sensor 122. In FIG. 3, distance sensor 122 may emit an electromagnetic beam 302 to user 150; the return electromagnetic beam 304 (e.g., beam reflected/scattered from user 150) may be analyzed (e.g., through processor 104) to determine changes thereto and, thereby, distance 306 between user 150 and display unit 110/data processing device 100. It is obvious that distance sensor 122 may be located in proximity to display unit 110 and that position thereof relative to display unit 110 may be fixed in order for the distance sensing to be accurate.

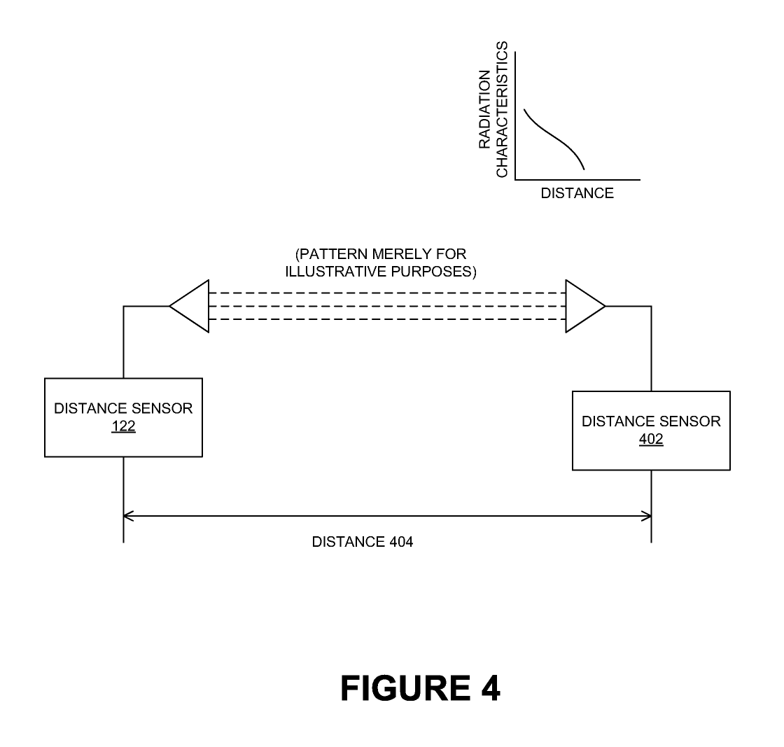

FIG. 4 shows an alternate embodiment of distance sensor 122. Here, another distance sensor 402 may be placed at the end of user 150. Distance sensor 122 at the end of data processing device 100/display unit 110 and distance sensor 402 may be antennas configured to transmit electromagnetic radiation therebetween. Depending on the distance (e.g., distance 404) between distance sensor 122 and distance sensor 402, the characteristic of the electromagnetic radiation may vary; sensing of distance 404 may, therefore, be possible. User 150 may have distance sensor 402 incorporated in a pair of goggles utilized for optimizing viewing of content on display unit 110 or other equipment amenable to accommodating distance sensor 402 therein.

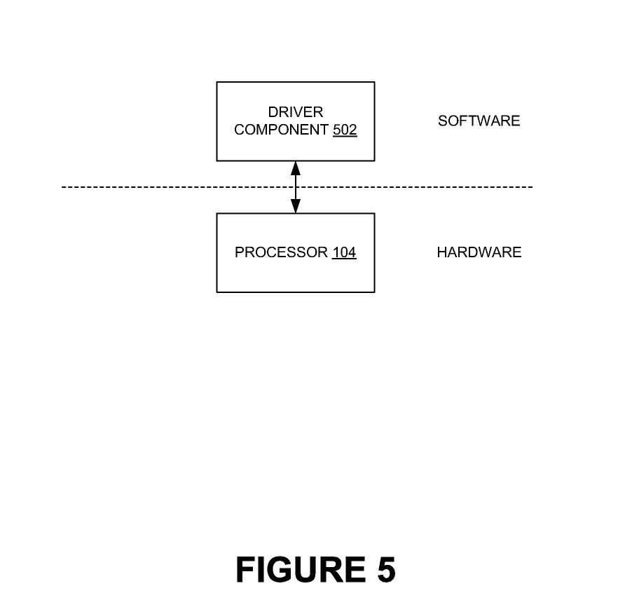

FIG. 5 shows interaction between a driver component 502 (e.g., a software driver) and processor 104, according to one or more embodiments. Upon initiation of the subtitle resizing process through user 150 based on actions discussed above or through loading of operating system 126, driver component 502 may be configured to cause (e.g., through processor 104) distance sensor 122 to sense distance between user 150 and display unit 110/data processing device 100. In one or more embodiments, based on the sensed distance between user 150 and display unit 110/data processing device 100, processor 104 may be configured to scale a subtitle of a video frame being rendered on display unit 110 to an appropriate size (e.g., a size that renders it easy for user 150 to discern and view content on display unit 110).

It is obvious that processor 104/multimedia processing unit 106 may execute instructions to receive sensed data from distance sensor 122, to analyze the sensed data to determine the distance between user 150 and display unit 110/data processing device 100 and to scale the size of the subtitle (e.g., based on subtitle data 206) to be tagged onto the video frame to an appropriate size. Further, it is obvious that exemplary embodiments are not limited to scaling subtitle size and that scaling sizes of other elements (e.g., zooming in on a character, a portion of the video frame) of the video frame or an image to be rendered on display unit 110 are within the scope of the exemplary embodiments. Here, the elements to be scaled may be stored separately from the image/video frame to be later overlaid on the image/video frame rendered on display unit 110.

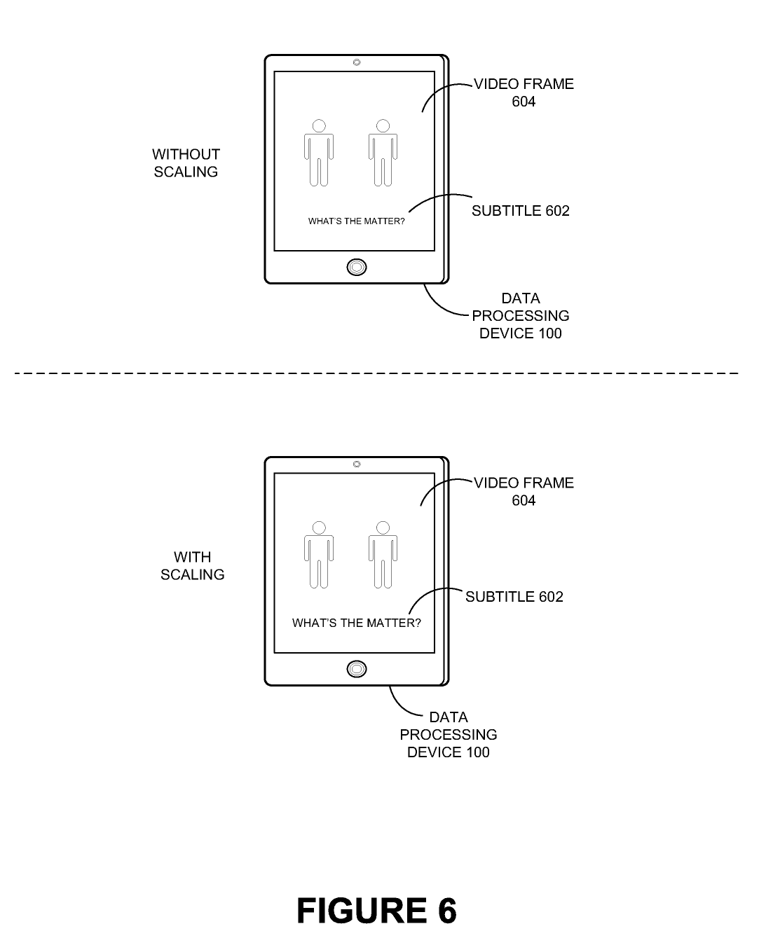

FIG. 6 illustrates the scaling of a subtitle 602 of a video frame 604 rendered on display unit 110. Upon processor 104 determining the distance between user 150 and display unit 110/data processing device 100, processor 104 may be configured to scale subtitle data 206 appropriately to render an enlarged version thereof on display unit 110.

The driver component (e.g., driver component 502) discussed above or equivalent software thereof discussed above may be stored in memory 102 to be installed on data processing device 100 after a download through the Internet. Alternately, an external memory may be utilized therefor. Also, instructions associated with the driver component may be embodied on a non-transitory medium readable through data processing device 100 such as a Compact Disc (CD), a Digital Video Disc (DVD), a Blu-ray™ disc, a floppy disk, or a diskette etc. The aforementioned instructions may be executable through data processing device 100.

The set of instructions associated with the driver component or equivalent software thereof is not limited to specific embodiments discussed above, and may, for example, be implemented in operating system 126, an application program, a foreground or a background process, a network stack or any combination thereof. Other variations are within the scope of the exemplary embodiments discussed herein.

It is to be noted that data processing device 100 preferably is a mobile device such as a mobile phone. While it is easier to determine distance between user 150 and display unit 110/data processing device 100 in the case of a mobile phone and difficult in the case of, say, a smart television possibly having a number of viewers associated therewith, concepts discussed herein are applicable to all possible forms of data processing device 100.

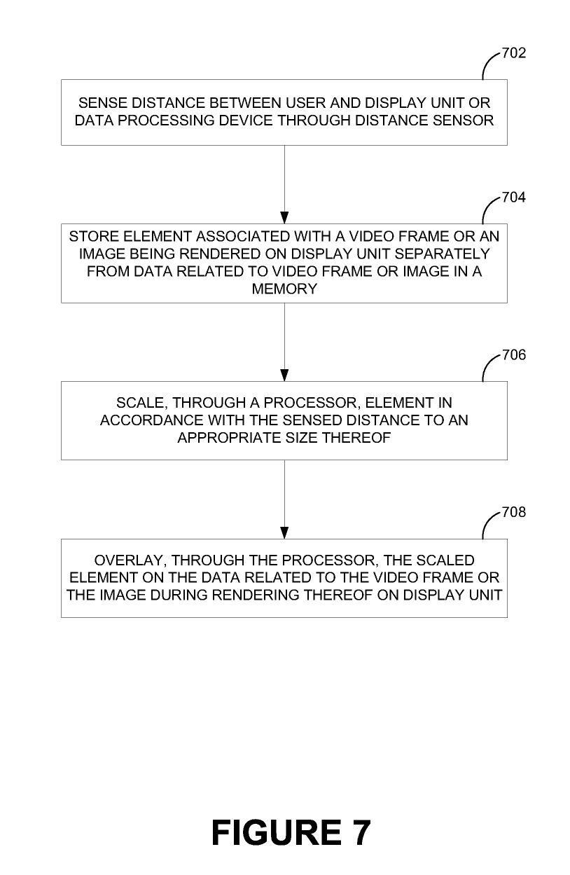

FIG. 7 shows a process flow diagram detailing the operations involved in adaptively scaling a video frame/image element rendered on data processing device 100, according to one or more embodiments. In one or more embodiments, operation 702 may involve sensing distance (e.g., distance 306, distance 404) between user 150 and display unit 110 or data processing device 100 through distance sensor 122. In one or more embodiments, operation 704 may involve storing an element associated with a video frame or an image being rendered on display unit 110 separately from data related to the video frame or the image in memory 102.

In one or more embodiments, operation 706 may involve scaling, through processor 104, the element in accordance with the sensed distance to an appropriate size thereof. In one or more embodiments, operation 708 may then involve overlaying, through processor 104, the scaled element on the data related to the video frame or the image during rendering thereof on display unit 110.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structure and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine accessible medium compatible with a data processing system (e.g., data processing device 100), and may be performed in any order (e.g., including using means for achieving the various operations). Accordingly, the specification and drawings are to be regarded in an illustrative rather than a restrictive sense.

What is claimed is:

1. A method comprising:
sensing distance between a user of a data processing device and one of a display unit of the data processing device and the data processing device through a distance sensor;
storing an element associated with one of a video frame and an image being rendered on the display unit separately from data related to the one of the video frame and the image in a memory associated with a processor of the data processing device;
scaling, through the processor, the element in accordance with the sensed distance to an appropriate size thereof; and
overlaying, through the processor, the scaled element on the data related to the one of the video frame and the image during rendering thereof on the display unit.

2. The method of claim 1, comprising initiating the sensing of the distance and the scaling of the element through a driver component associated with at least one of the processor, an operating system executing on the data processing device, and an application program executing on the data processing device.

3. The method of claim 1, wherein the element associated with the one of the video frame and image is a subtitle.

4. The method of claim 1, wherein the distance sensor is one of:
configured to transmit electromagnetic radiation to the user such that a characteristic of a reflected beam thereof is configured to be analyzed at the processor to determine the distance, and
a set of antennas configured to transmit electromagnetic radiation therebetween, a characteristic of the electromagnetic radiation being dependent on the distance to be sensed.

5. The method of claim 1, wherein the data processing device is one of a mobile device, a desktop computer, a laptop computer, a netbook, a notebook computer and a gaming console.

6. The method of claim 1, wherein the scaling of the element is part of encoding of the one of the video frame and the image through the processor.

7. The method of claim 1, wherein at least one of:
the processor is one of a Central Processing Unit (CPU) and a Graphics Processing Unit (GPU), and
the memory is at least one of a volatile memory and a non-volatile memory.

8. A non-transitory medium, readable through a data processing device and including instructions embodied therein that are executable through the data processing device, comprising:
instructions to sense distance between a user of the data processing device and one of a display unit of the data processing device and the data processing device through a distance sensor;
instructions to store an element associated with one of a video frame and an image being rendered on the display unit separately from data related to the one of the video frame and the image in a memory associated with a processor of the data processing device;
instructions to scale, through the processor, the element in accordance with the sensed distance to an appropriate size thereof; and
instructions to overlay, through the processor, the scaled element on the data related to the one of the video frame and the image during rendering thereof on the display unit.

9. The non-transitory medium of claim 8, comprising instructions to initiate the sensing of the distance and the scaling of the element through a driver component associated with at least one of the processor, an operating system executing on the data processing device, and an application program executing on the data processing device.

10. The non-transitory medium of claim 8, comprising instructions to scale a subtitle as the element associated with the one of the video frame and image.

11. The non-transitory medium of claim 8, comprising instructions to sense the distance through the distance sensor that is one of:
configured to transmit electromagnetic radiation to the user such that a characteristic of a reflected beam thereof is configured to be analyzed at the processor to determine the distance, and
a set of antennas configured to transmit electromagnetic radiation therebetween, a characteristic of the electromagnetic radiation being dependent on the distance to be sensed.

12. The non-transitory medium of claim 8, comprising instructions to perform the scaling of the element as part of encoding of the one of the video frame and the image through the processor.

13. The non-transitory medium of claim 8, comprising instructions to communicate between one of a CPU and a GPU as the processor and at least one of a volatile memory and a non-volatile memory as the memory.

14. A data processing device comprising:
a display unit;
a memory having an element associated with one of a video frame and an image being rendered on the display unit stored separately from data related to the one of the video frame and the image;
a processor communicatively coupled to the memory; and
a distance sensor to sense distance between a user of the data processing device and one of the display unit of the data processing device and the data processing device, the processor being configured to scale the element in accordance with the sensed distance to an appropriate size thereof, and to overlay the scaled element on the data related to the one of the video frame and the image during rendering thereof on the display unit.

15. The data processing device of claim 14, further comprising a driver component associated with at least one of the processor, an operating system executing thereon and an application program executing thereon to initiate the sensing of the distance and the scaling of the element.

16. The data processing device of claim 14, wherein the element associated with the one of the video frame and image is a subtitle.

17. The data processing device of claim 14, wherein the distance sensor is one of:
configured to transmit electromagnetic radiation to the user such that a characteristic of a reflected beam thereof is configured to be analyzed at the processor to determine the distance, and
a set of antennas configured to transmit electromagnetic radiation therebetween, a characteristic of the electromagnetic radiation being dependent on the distance to be sensed.

18. The data processing device of claim 14, wherein the data processing device is one of a mobile device, a desktop computer, a laptop computer, a netbook, a notebook computer and a gaming console.

19. The data processing device of claim 14, wherein the processor is configured to scale the element as part of encoding of the one of the video frame and the image.

20. The data processing device of claim 14, wherein at least one of:
the processor is one of a CPU and a GPU, and
the memory is at least one of a volatile memory and a non-volatile memory.
